(19) United States
(12) Patent Application Publication
(10) Pub. No.: US 2019/0155713 A1
(43) Pub. Date: May 23, 2019

(54) APPLICATION PERFORMANCE MONITORING

(71) Applicant: ENTIT SOFTWARE LLC, SANFORD, NC (US)

(72) Inventors: Nevoh Yemini, Yehud (IL); Roy Sela, Yehud (IL); Yuri Ronin, Yehud (IL)

(21) Appl. No.: 16/092,128

(22) PCT Filed: Apr. 12, 2016
(86) PCT No.: PCT/US2016/027111

§ 371 Date: Oct. 8, 2018

(51) Int. Cl. G06F 11/34; G06F 11/30; G06F 9/54

(52) U.S. Cl. CPC G06F 11/3409; G06F 11/3093; G06F 2201/87; G06F 9/54; G06F 2201/865; G06F 11/302

(57) ABSTRACT

Examples include monitoring performance of an application. Some examples include tracing a set of transactions associated with an application, generating a transaction interface that includes an area to receive a selection of a transaction of the set of transactions, and receiving a selected transaction. Based on the selected transaction, a transaction monitor rule may be built to monitor the selected transaction. Based on the transaction monitor rule, a performance interface may be generated that includes an area having transaction performance information of the selected transaction.

### BACKGROUND

Applications may be used to perform a wide variety of tasks in computing and networking systems. In some examples, applications may be designed for mobile computing devices, whereas in other examples, applications may be designed for desktop, laptop, server, or other suitable configurations. Applications may be accessed and used by customers, clients, users, and other applications via transaction calls. Owners, administrators, and developers of applications may desire application performance information associated with such transaction calls to detect or diagnose performance issues, vulnerabilities, and/or to identify application areas that are performing well.

### BRIEF DESCRIPTION OF THE DRAWINGS

The following detailed description references the drawings, wherein:

FIG. 1A is a block diagram of an example machine-readable storage medium having instructions executable by a processor to monitor performance of an application by generating a transaction interface including an area to receive a selection of a transaction and building a transaction monitor rule based on the selected transaction;

FIG. 1B is a block diagram of example instructions to trace a set of transactions;

FIG. 1C is a block diagram of example instructions to build a transaction monitor rule;

FIG. 1D is a block diagram of an example machine-readable storage medium having instructions executable by a processor to monitor performance of an application by generating a rule interface;

FIG. 2A is a block diagram of an example machine-readable storage medium having instructions executable by a processor to monitor performance of an application by tracing a set of transactions, a set of methods, and a set of statements;

FIG. 2B is a block diagram of example instructions to build a transaction monitor rule, build a method monitor rule, and build a statement monitor rule:

FIG. 3A is an example of a transaction interface that includes an area to receive a selection of a transaction;

FIG. 3B is an example of a transaction interface that includes an area to receive a selection of a method;

FIG. 30 is an example of a transaction interface that includes an area to receive a selection of a statement;

FIG. 4A is an example of a performance interface that includes an area having transaction performance information;

FIG. 4B is an example of a performance interface that includes an area having method performance information;

FIG. 4C is an example of a performance interface that includes an area having statement performance information; and

FIG. 5 is an example of a rule interface that includes an area having each selected transaction, an area having each selected method, and an area having each selected statement;

FIG. 6A is a block diagram of an example computing device comprising a processor to trace a set of operations, send the set of operations to a filtering device, and receive from the filtering device a set of transactions;

FIG. 6B is a block diagram of an example computing device comprising a processor and a user interface that includes a transaction interface, a performance interface, and a rule interface; and

FIG. 7 is a flowchart of an example method of monitoring performance of an application including tracing a set of transactions, a set of methods, and a set of statements, and generating a transaction interface that includes an area to receive a selection of a transaction, a method, and a statement.

### DETAILED DESCRIPTION

Applications may provide a variety of different functionalities to allow performance of a wide variety of tasks. In some examples, customers, clients, users, and other applications may access or use an application by way of transaction calls. A transaction call may represent a transaction to be performed by or at the application. As described herein, a transaction may refer to a set of actions that may be treated as a unit. An application may allow for the performance or execution of hundreds or even thousands of different types of transactions. In turn, these different types of transactions may be accessed hundreds or even thousands of times an hour via transaction calls. Application owners, administrators, and developers may desire access to this information to determine relevant application performance information.

In some examples, application performance management services may collect transaction data. Given the amount of data associated with each transaction and transaction call, in conjunction with the bandwidth required to collect such data, an application performance management service may collect data for a fixed type of transaction, a fixed number of transactions, and a fixed number of instances of transactions and present this information to application owners, administrators, or developers. Changes in the collection of data may require manual adjustment or reprogramming of the collection mechanism for individual applications or may result in changes across all applications.

Collecting data associated with a fixed type of transactions or a fixed number of transactions may, however, result in the collection of irrelevant data, a failure to capture relevant data, and/or the obfuscation of relevant data, while failing to minimize overhead or optimize bandwidth usage. As such, the application management service may not be suitable for providing relevant application performance data.

Examples described herein may improve the monitoring and provision of application performance information by allowing an application owner, administrator, developer, or other user to dynamically select a transaction, method, or argument to receive desired application performance information. For instance, some examples described herein may utilize a transaction interface that includes an area to receive a selection of a transaction. In such examples, based on the selected transaction, a transaction monitor rule may be dynamically built to monitor the selected transaction and may allow for efficient collection of relevant data associated with an application. A performance interface may be generated that includes an area to display transaction performance information of the selected transaction. Flexible and dynamic selection of transactions, methods within a transaction, and statements within a method may be allowed, permitting application-specific configurations for either high-level or fine-grained performance information, as may be desired.

In some examples described herein, a processor may execute instructions on a machine-readable storage medium to monitor performance of an application. The machine-readable storage medium may be encoded with instructions to trace a set of transactions associated with the application and to cause the generation of a transaction interface that includes an area to receive a selection of a transaction of the set of transactions. The instructions may further include instructions to receive a selected transaction of the set of transactions and, based on the selected transaction, build a transaction monitor rule to monitor the selected transaction. Based on the transaction monitor rule, the instructions may cause the generation of a performance interface that includes an area having transaction performance information of the selected transaction.

In some examples described herein, a computing device comprising a user interface and a processor may monitor performance of an application. The processor may trace a set of operations associated with the application, send the set of operations to a filtering device, and receive a set of transactions within the set of operations from the filtering device. The processor may further generate a transaction interface in the user interface that includes an area to receive a selection of a transaction. The processor may receive a selected transaction of the set of transactions and build, based on the selected transaction, a transaction monitor rule to monitor the selected transaction. Based on the transaction monitor rule, the processor may generate a performance interface in the user interface that includes transaction performance information of the selected transaction.

In some examples described herein, a method for monitoring performance of an application may trace a set of transactions associated with the application, a set of methods within the set of transactions, and a set of statements with the plurality of methods. A transaction interface may be generated that includes an area to receive a selection of a transaction of the set of transactions, an area to receive a selection of a method of the set of methods, and an area to receive a selection of a statement of the set of statements. Upon receiving at least one of a selected transaction, a selected method, and a selected statement, a transaction monitor rule based on the selected transaction to monitor the selected transaction, a method monitor rule based on the selected method to monitor the selected method, and a statement monitor rule based on the selected statement to monitor the selected statement may be built. Based on at least one of the transaction monitor rule, the method monitor rule, and the statement monitor rule, a performance interface may be generated that includes at least one of an area having transaction performance information of the selected transaction, an area having method performance information of the selected method, and an area having statement performance information of the selected statement, respectively.

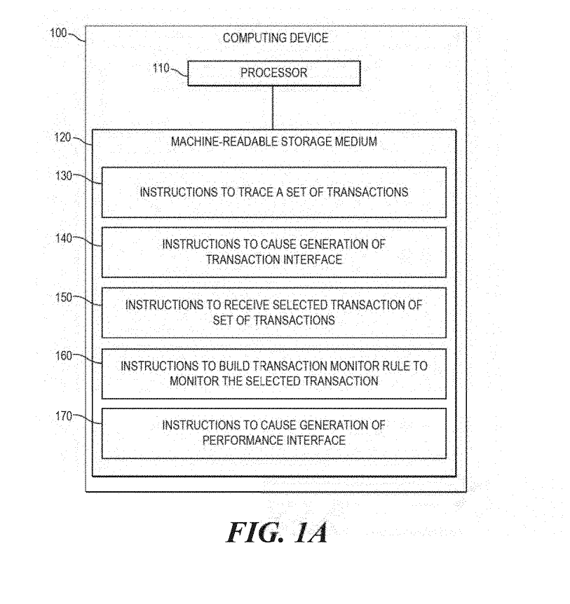

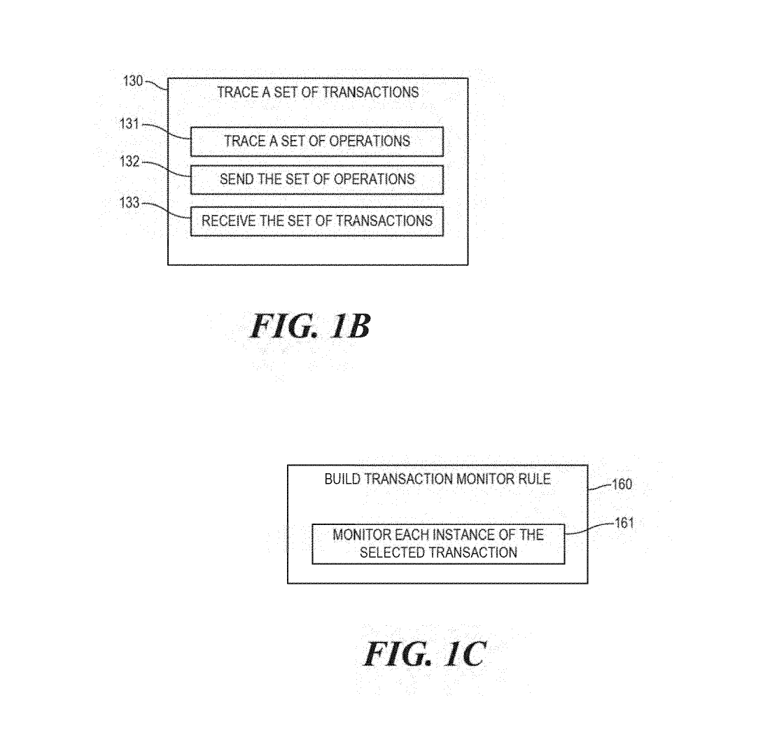

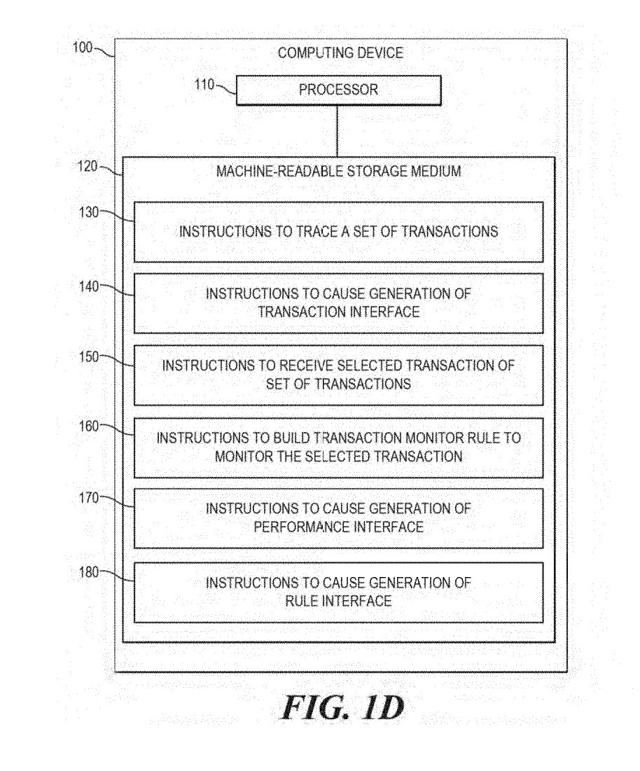

Referring now to the drawings, FIG. 1A is a block diagram of an example computing device 100 to monitor performance of an application. Computing device 100 includes a processor 110 and a machine-readable storage medium 120 comprising (e.g., encoded with) instructions 130, 140, 150, 160, and 170 executable by processor 110 to implement functionalities described herein in relation to FIG. 1A. In some examples, storage medium 120 may include additional instructions such as instructions 131, 132, 133, and 161. In other examples, the functionalities described herein in relation to instructions 130, 140, 150, 160, 170, and any additional instructions described herein in relation to storage medium 120, may be implemented at least in part in electronic circuitry (e.g., via engines comprising any combination of hardware and programming to implement the functionalities of the engines, as described below).

As used herein, a computing device may be a desktop computer, laptop (or notebook) computer, workstation, tablet computer, mobile phone, smart device, switch, router, server, blade enclosure, or any other processing device or equipment including a processor or processing resource. In examples described herein, a processor may include, for example, one processor or multiple processors included in a single computing device or distributed across multiple computing devices.

As used herein, a processor may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof.

Processor 110 may fetch, decode, and execute instructions stored on storage medium 120 to perform the functionalities described below in relation to instructions 130, 140, 150, 160, and 170. In other examples, the functionalities of any of the instructions of storage medium 120 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the example of FIG. 1A, storage medium 120 may be implemented by one machine-readable storage medium, or multiple machine-readable storage media.

As used herein, a machine-readable storage medium may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory. In examples described herein, a machine-readable storage medium or media may be part of an article (or article of manufacture). An article or article of manufacture may refer to any manufactured single component or multiple components.

In the example of FIG. 1A, instructions 130 may trace a set of transactions associated with an application. An application, as used herein, may refer to a computer program designed to perform a set of functions, tasks, activities, and operations. Applications may be designed for many different computing or networking environments, including, mobile computing devices, desktop configurations, laptops, and server configurations. In some examples an application may be accessed or used by a customer, client, user, or another application via a transaction call. A transaction call may represent a transaction to be performed by or at the application. As described herein, a transaction may refer to a set of actions that may be treated as a unit. In some examples, the transaction call may be an application programming interface (API) call.

Tracing a set of transactions may involve detecting a transaction call to an application and further detecting the application's response to the transaction call. In some examples, this may involve following or tracing all or some of the programming code employed to respond to the transaction call. In such examples, the code employed to respond to a transaction call may be grouped by call and stored for further analysis by instructions 130. In other examples, tracing a set of transactions may involve detecting all transaction calls to an application and detecting any programming code employed to respond to the calls. In some such examples instructions 130 may group an application's responses to the calls by each call or by transaction type. In other such examples, instructions 130 may send an applications' responses to the transaction calls to another service or device for storage and/or analysis. Information relating to the tracing of the set of transactions may be stored at computing device 100 or stored at a remote, but accessible device or storage medium to computing device 100.

In some examples, as depicted in the example of FIG. 1B, instructions 130 may further include instructions 131, 132, and 133. Instructions 131 may involve tracing a set of operations associated with the application. As used in the examples herein, a set of operations may refer to any functions, tasks, or activities performed by an application. In some examples, tracing a set of operations may encompass or involve tracing a set of transactions. The operations associated with the application may include any response by the application to a transaction call, for instance an API call, as well as any other actions taken, or functions and tasks performed by the application. Tracing a set of operations may involve detecting some or all of the programming code employed by the application.

In the example of FIG. 1B, instructions 132 may send the set of operations to a filtering device. Sending the set of operations may involve sending the programming code employed by the application associated with the set of operations. A filtering device, as used herein, may refer to a device that receives a set of operations and filters the operations. The filtering device may be part of computing device 100 or may be located remote from, but accessible to computing device 100 (e.g., via a computer network). In some examples, the filtering device may receive a set of operations and filter the set of operations to a set of transactions. In such examples, the filtering device may receive programming code associated with a set of operations and filter or group the programming code by transaction type or by transaction call. Such filtering or grouping may involve analyzing the code to determine which code is associated with a particular transaction call or a particular transaction type. Instructions 133 may receive a set of transactions, filtered from the set of operations, from the filtering device.

Based (at least in part) on the set of transactions, instructions 140 in the example of FIG. 1A may cause the generation of a transaction interface that includes an area to receive a selection of a transaction of the set of transactions. As used in the examples herein, a transaction interface may be any interface associated with a set of transactions that allows a customer, client, or user to communicate with a computing device. The transaction interface may be displayed in any manner suitable for representing content associated with the set of transactions. In some examples, the transaction interface may be generated and displayed as a web page or multiple web pages displayed within a web browser. In other examples, the transaction interface may be displayed as an interactive multimedia file within an application performance management service. In yet other examples, the transaction interface may be displayed as a word processing or PDF file.

The transaction interface may include an area to receive a selection of a transaction of the set of transactions. For instance, a transaction interface displayed as a web page within a web browser may display a list of transactions within the set of transactions. Each listed transaction may allow for selection by a user via a click of a mouse button, a touch gesture on a touch-enabled display, or other similar input mechanism.

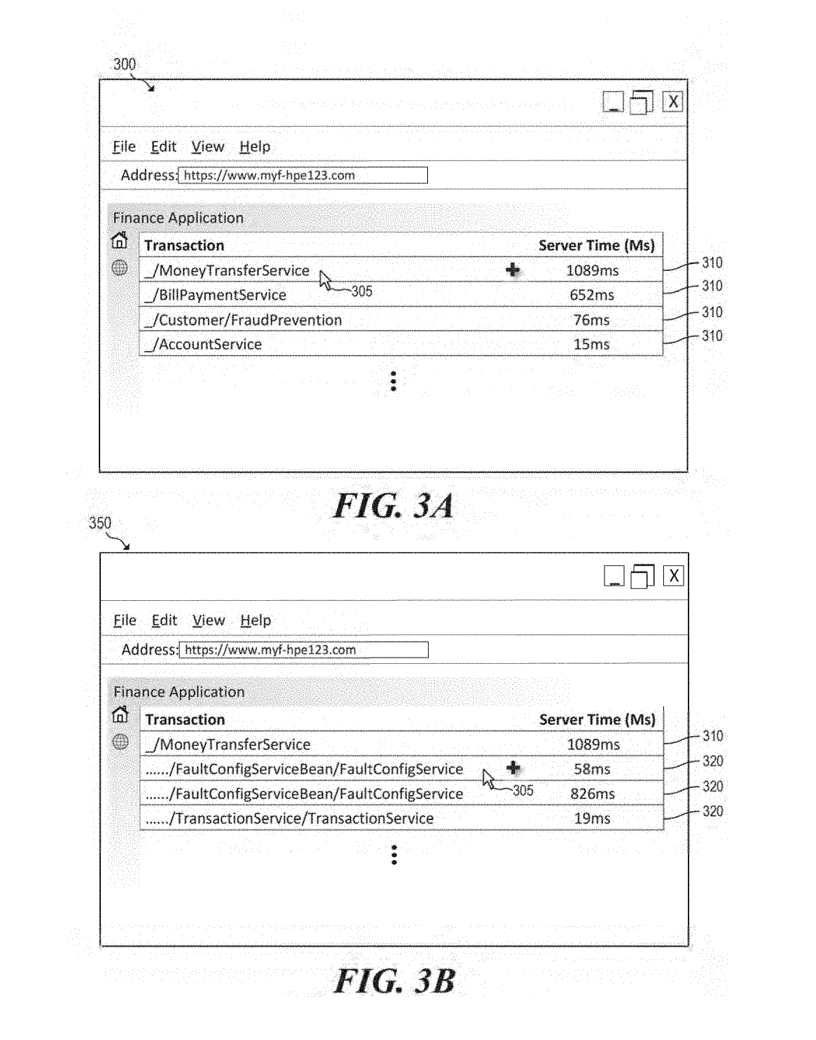

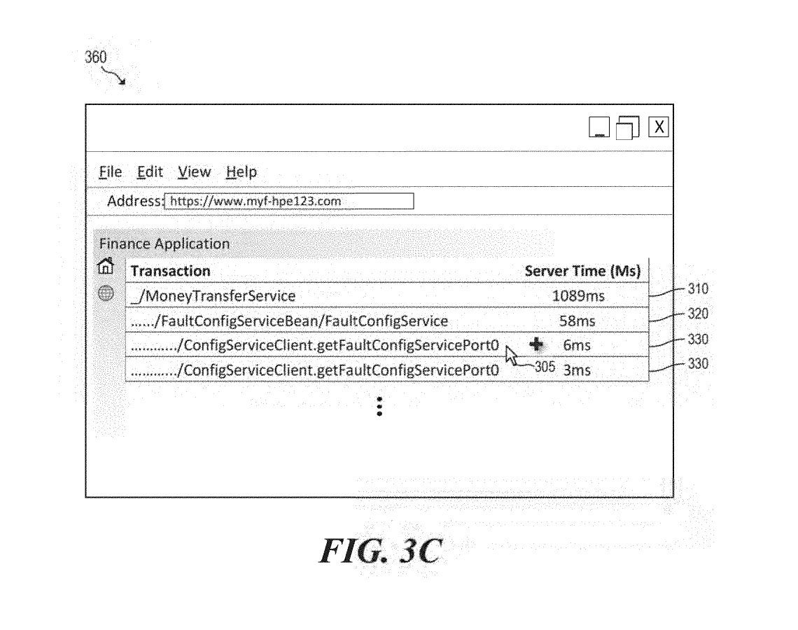

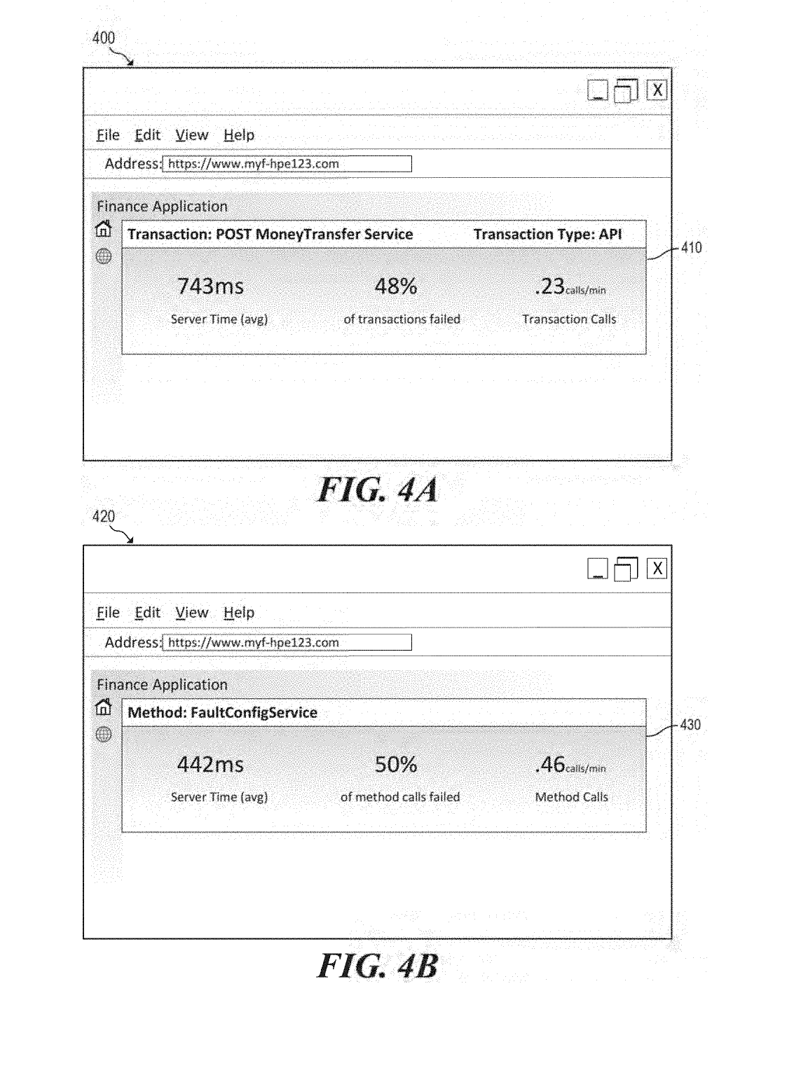

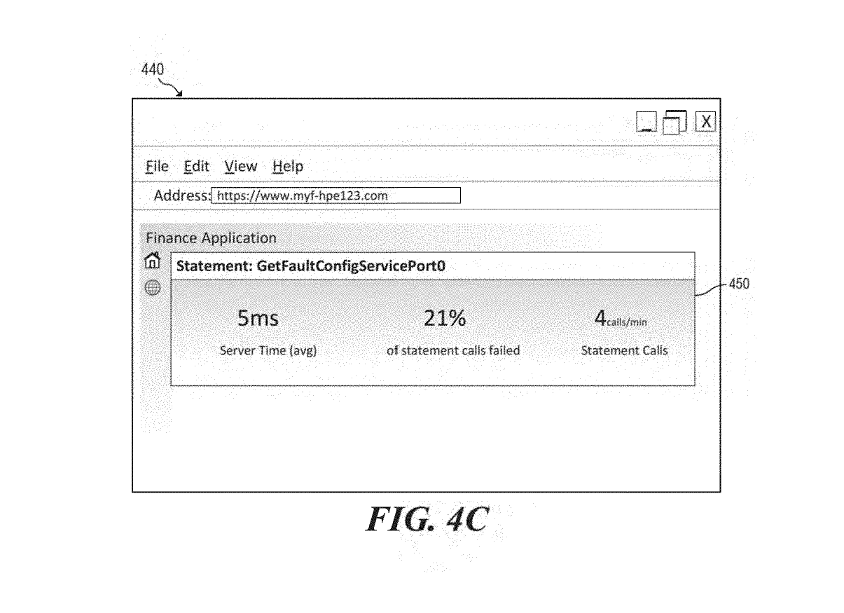

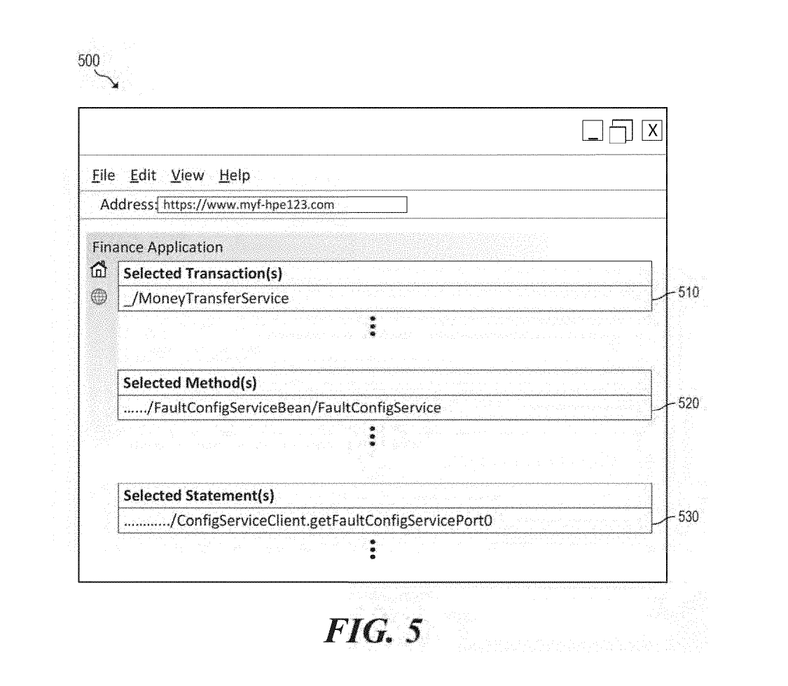

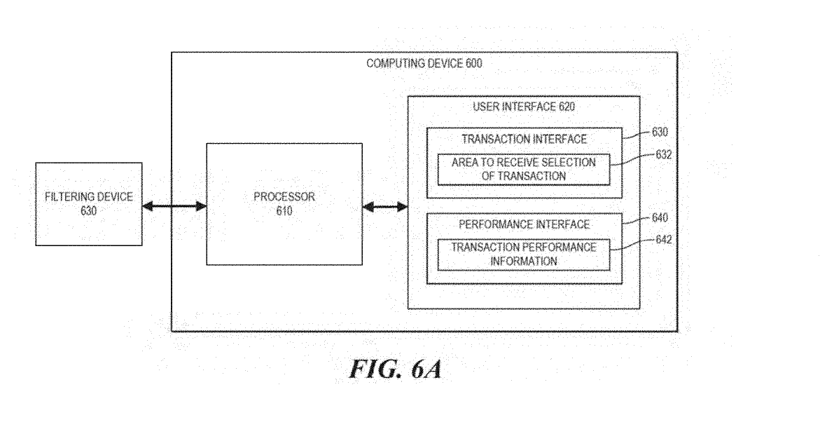

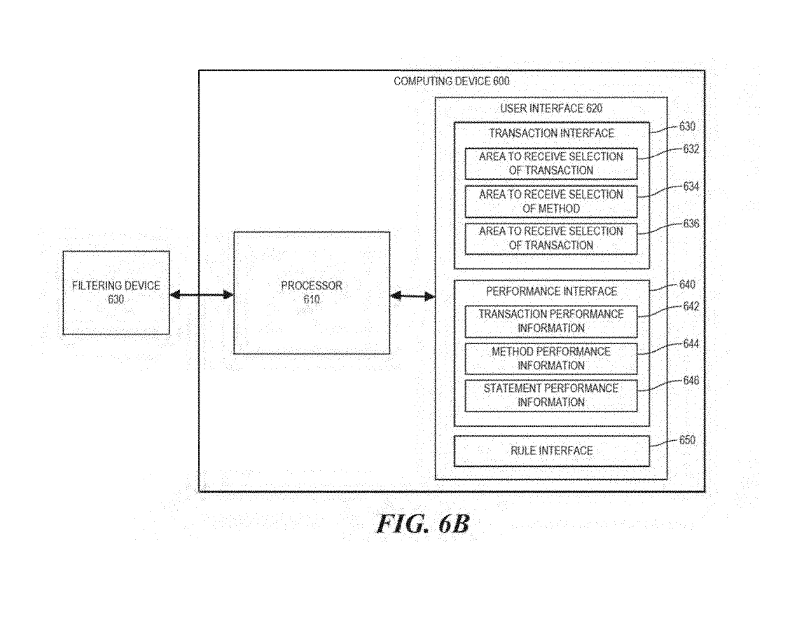

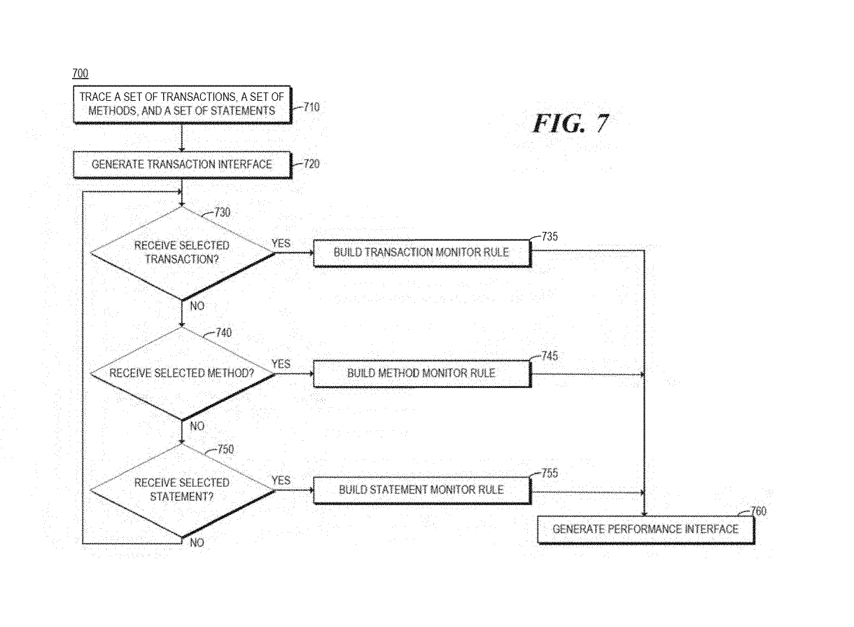

FIG. 3A depicts an example transaction interface 300 that includes an area to receive a selection of a transaction. In the example of FIG. 3A, transaction interface 300 is shown as a web page within a web browser and displays transactions related to a “Finance Application.” As discussed above, however, the transaction interface is not limited to such a configuration. Transaction interface 300 includes multiple transactions 310, depicted in rows, of the set of transactions. Mouse movement over a transaction 310, as depicted by mouse arrow 305, may cause a button, link, or other indication such as a “+” to appear that allows selection of the transaction 310 by mouse click, touch gesture, or other suitable input mechanism. In other examples, a mouse click or touch gesture over any portion of the row in which transaction 310 is depicted may allow for selection of the transaction 310. In some examples, selection of the “+” indication may allow for monitoring of the specific transaction type via a transaction monitor rule, as discussed in further detail with regards to instructions 160 of FIG. 1A below, whereas selection of another portion of the row in which transaction 310 is depicted may display additional information with regards to the particular transaction 310, i.e., when transaction 310 was performed, what entity requested transaction 310, etc. In the example depicted in FIG. 3A, selection of the “+” indication allows for selection of the transaction type “MoneyTransferService.” In some examples, the transaction interface may allow a customer, client, or other user to select any number of transactions of the set of transactions. In other examples, the transaction interface may allow for selection of a limited number of transactions.

Returning to FIG. 1A, upon selection of a transaction by a customer, client, or other user at the transaction interface, instructions 150 may receive the selected transaction of the set of transactions from the transaction interface. In some examples, selection of a transaction may automatically assign the transaction type a transaction signature with which to identify the selected transaction. In such examples, receiving the selected transaction may include receiving the transaction signature. In other examples, instructions 150 may receive the selected transaction and assign a transaction signature to the selected transaction.

Based (at least in part) on the selected transaction, instructions 160 may build and apply a transaction monitor rule to the monitored application to monitor the selected transaction. As used herein, a transaction monitor rule may refer to a rule to monitor the selected transaction. In some examples, as shown in FIG. 1C, instructions 160 to build the transaction monitor rule may comprise instructions 161 to monitor each instance of the selected transaction type. The selected transaction may be identified by its transaction signature. Monitoring a selected transaction may involve detecting and tracing the programming code employed by the application to perform or execute the transaction.

As an example, a transaction monitor rule based (at least in part) on the selection of transaction type “MoneyTransferService,” as shown in FIG. 3A, would contain instructions or commands to monitor each instance of the transaction “MoneyTransferService.” In some examples, each instance of the transaction “MoneyTransferService” may be represented by the API call “MoneyTransferService.”

In other examples, the transaction monitor rule may contain instructions or commands to monitor only specific instances of a particular transaction type, for example, each instance originating from a certain entity or each instance occurring within a certain time frame. In such examples, upon selection of a transaction of the set of transactions, a user may be prompted to select additional qualifiers to build the transaction monitor rule. Instructions 160 may automatically and dynamically build the transaction monitor rule upon selection of the selected transaction and/or selection of additional qualifiers.

Based (at least in part) on the transaction monitor rule, instructions 170 may cause the generation of a performance interface that includes an area having transaction performance information of the selected transaction. As used in the examples herein, a performance interface may be any interface associated with the performance of a selected transaction that may allow a customer, client, or user to communicate with a computing device. The performance interface may be displayed in any manner suitable for representing content associated with the selected transaction. In some examples, the performance interface may be generated and displayed as a web page or multiple web pages displayed within a web browser. In other examples, the performance interface may be displayed as an interactive multimedia file within an application performance management service. In yet other examples, the performance interface may be displayed as a word processing or PDF file.

Instructions 170 may cause the generation of a performance interface by requesting or otherwise receiving information gathered due to the transaction monitor rule. In some examples, this information may be located at computing device 100 or at a remote, but accessible device or storage medium to computing device 100. This information may include, among other things, the programming code employed to respond to each instance of the selected transaction, the latency of each instance of the selected transaction, and/or error messages generated in the performance or execution of a transaction. Analytics may be performed on this information to generate transaction performance information.

The performance interface may include an area having transaction performance information of the selected transaction. As used in the examples herein, transaction performance information may refer to performance information related to the selected transaction. For instance, depending on the transaction monitor rule, the performance interface may display each instance (i.e., transaction call) of the selected transaction, the latency of each instance of the selected transaction, an average latency for the selected transaction, the percentage of the selected transactions that fail, the number of selected transaction calls per minute, an operation flow of the selected transaction depicting the set of operations and actions that comprise the transaction, information about the individual operations within the operation flow such as latency and failure rate, and a log message capture of error or fault messages per instance of the selected transaction or in the aggregate.

FIG. 4A depicts an example performance interface 400 that includes an area 410 having transaction performance information of the selected transaction. In the example of FIG. 4A, performance interface 400 is shown as a web page within a web browser and displays the performance of a transaction related to a “Finance Application.” As discussed above, however, the performance interface is not limited to such a configuration. Area 410 of performance interface 400 depicts transaction performance information related to the selected transaction “MoneyTransferService.” As shown, area 410 includes transaction performance information relating to the average server time for the transaction “MoneyTransferService,” the percentage of transactions failed, and the number of transaction calls per minute. Though not shown in performance interface 400, the performance interface may include additional areas to allow for the display of further transaction performance information. In some examples, the performance interface may allow a customer, client, or user to select and display transaction performance information that shows, among other things, an operation flow of the selected transaction or a log message capture of the selected transaction.

In some examples, instructions 130, 140, 150, 160, and 170 may be part of an installation package that, when installed, may be executed by processor 110 to implement the functionalities described above. In such examples, storage medium 120 may be a portable medium, such as a CD, DVD, or flash drive, or a memory maintained by a server from which the installation package can be downloaded and installed. In other examples, instructions 130, 140, 150, 160, and 170 may be part of an application, applications, or component(s) already installed on computing device 100 including processor 110. In such examples, the storage medium 120 may include memory such as a hard drive, solid state drive, or the like. In some examples, functionalities described herein in relation to any of FIGS. 1A-C, 3A, and 4A may be provided in combination with functionalities described herein in relation to any of FIGS. 1D, 2, 3B-C. 4B-C, and 5-7.

FIG. 1D is a block diagram of the example computing device 100 to monitor performance of an application that includes instructions to cause the generation of a rule interface. Computing device 100 includes a processor 110 and a machine-readable storage medium 120 comprising (e.g., encoded with) instructions 130, 140, 150, 160, 170, and 180 executable by processor 110 to implement functionalities described herein in relation to FIG. 10. In some examples, storage medium 120 may include additional instructions such as instructions 131, 132, 133, and 161. In other examples, the functionalities described herein in relation to instructions 130, 140, 150, 160, 170, 180, and any additional instructions described herein in relation to storage medium 120, may be implemented at least in part in electronic circuitry (e.g., via engines comprising any combination of hardware and programming to implement the functionalities of the engines, as described below).

Processor 110 may fetch, decode, and execute instructions stored on storage medium 120 to perform the functionalities described above in relation to instructions 130, 140, 150, 160, 170, and 180. In other examples, the functionalities of any of the instructions of storage medium 120 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the example of FIG. 1D, storage medium 120 may be implemented by one machine-readable storage medium, or multiple machine-readable storage media.

In the example of FIG. 1D, instructions 130 may trace a set of transactions associated with an application, as described above in relation to instructions 130 of FIGS. 1A and 1B. Instructions 140 may cause the generation of a transaction interface that includes an area to receive a selection of a transaction of the set of transactions, as described above in relation to instructions 140 of FIG. 1A and transaction interface 300 of FIG. 3A. Instructions 150 may receive a selected transaction of the set of transactions, as described above in relation to instructions 150 of FIG. 1A. Based (at least in part) on the selected transaction, instructions 160 may build and apply a transaction monitor rule to the monitored application to monitor the selected transaction, as described above in relation to instructions 160 of FIGS. 1A and 1C. Based (at least in part) on the transaction monitor rule, instructions 170 may cause the generation of a performance interface that includes an area having transaction performance information of the selected transaction, as described above in relation to instructions 170 of FIG. 1A and performance interface 400 of FIG. 4A.

Instructions 180 may cause the generation of a rule interface that includes an area that has each selected transaction. As used in the examples herein, a rule interface may be any interface that includes each selected transaction, selected method, and/or selected statement and that may allow a customer, client, or user to communicate with a computing device. The rule interface may be displayed in any manner suitable for representing content that includes each selected transaction. In some examples, the rule interface may be generated and displayed as a web page or multiple web pages displayed within a web browser. In other examples, the rule interface may be displayed as an interactive multimedia file within an application performance management service. In yet other examples, the rule interface may be displayed as a word processing or PDF file.

Instructions 180 may cause the generation of a rule interface by requesting or otherwise receiving information related to each selected transaction. The rule interface may include an area having each selected transaction. For example, each selected transaction may be listed or otherwise depicted in the rule interface. FIG. 5 depicts an example rule interface 500 that includes an area 510 having each selected transaction. In the example of FIG. 5, rule interface 500 is shown as a web page within a web browser and displays each selected transaction related to a “Finance Application.” As discussed above, however, the rule interface is not limited to such a configuration. Area 510 of rule interface 500 depicts the selected transaction “MoneyTransferService.” In some examples, though not illustrated in FIG. 5, a customer, client, or user may de-select a selected transaction, causing the removal of the transaction monitor rule. In some such examples, mouse movement over a listed transaction may cause a button, link, or other indication such as a “−” to appear that allows de-selection of the transaction by mouse click, touch gesture, or other suitable input mechanism. In other examples, a mouse click or touch gesture over any portion of the row in which the selected transaction is depicted may allow for de-selection of the transaction. In some examples, selection of the “−” Indication may discontinue specific monitoring of the transaction type, whereas selection of another portion of the row in which the transaction is depicted may display additional information with regards to the particular transaction, i.e., when the selected transaction was last performed, when selection of the selected transaction was requested, etc.

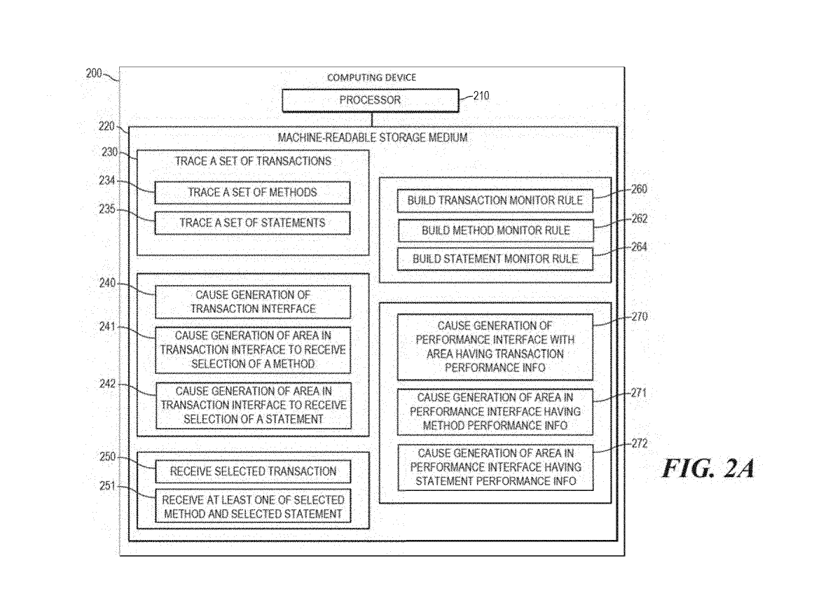

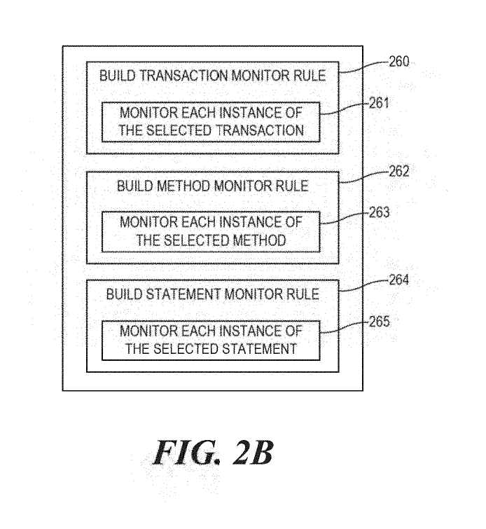

In some examples, instructions 130, 140, 150, 160, 170, and 180 may be part of an installation package that, when installed, may be executed by processor 110 to implement the functionalities described above. In such examples, storage medium 120 may be a portable medium, such as a CD, DVD, or flash drive, or a memory maintained by a server from which the installation package can be downloaded and installed. In other examples, instructions 130, 140, 150, 160, 170, and 180 may be part of an application, applications, or component(s) already installed on computing device 100 including processor 110. In such examples, the storage medium 120 may include memory such as a hard drive, solid state drive, or the like. In some examples, functionalities described herein in relation to any of FIGS. 1, 3A, 4A, and 5 may be provided in combination with functionalities described herein in relation to any of FIGS. 2, 3B-C, 4B-C, and 6-7.

FIG. 2A is a block diagram of an example computing device 200 to monitor performance of an application that includes instructions to trace a set of transactions, a set of methods, and a set of statements. Computing device 200 includes a processor 210 and a machine-readable storage medium 220 comprising (e.g., encoded with) instructions 230, 240, 241, 242, 250, 251, 260, 262, 264, and 270 executable by processor 210 to implement functionalities described herein in relation to FIG. 2A. In some examples, storage medium 220 may include additional instructions such as instructions 231 and 232, 261, 263, and 265. In other examples, the functionalities described herein in relation to instructions 230, 240, 241, 242, 250, 251, 260, 262, 264, 270, and any additional instructions described herein in relation to storage medium 220, may be implemented at least in part in electronic circuitry (e.g., via engines comprising any combination of hardware and programming to implement the functionalities of the engines, as described below).

Processor 210 may fetch, decode, and execute instructions stored on storage medium 120 to perform the functionalities described above in relation to instructions 230, 240, 241, 242, 250, 251, 260, 262, 264, and 270. In other examples, the functionalities of any of the instructions of storage medium 220 may be implemented in the form of electronic circuitry, in the form of executable instructions encoded on a machine-readable storage medium, or a combination thereof. The storage medium may be located either in the computing device executing the machine-readable instructions, or remote from but accessible to the computing device (e.g., via a computer network) for execution. In the example of FIG. 2A, storage medium 220 may be implemented by one machine-readable storage medium, or multiple machine-readable storage media.

In the example of FIG. 2A, instructions 230 may trace a set of transactions associated with an application, as described above in relation to instructions 130 of FIGS. 1A and 1B. Tracing a set of transactions may involve detecting a transaction call to an application and further detecting the application's response to the transaction call. In some examples, this may involve following or tracing all or some of the programming code employed to respond to the transaction call. In such examples, the code employed to respond to a transaction call may be grouped by call and stored for further analysis by instructions 230. In other examples, tracing a set of transactions may involve detecting all transaction calls to an application and detecting any programming code employed to respond to the calls. In some such examples instructions 230 may group an application's responses to the calls by each call or by transaction type. In other such examples, instructions 230 may send an applications' responses to the transaction calls to another service or device for storage and/or analysis. Information relating to the tracing of the set of transactions may be stored at computing device 200 or stored at a remote, but accessible device or storage medium to computing device 200.

Instructions 230 to trace a set of transactions may also comprise, in some examples, instructions 234 to trace a set of methods within the set of transactions and instructions 235 to trace a set of statements within the set of methods. Tracing the set of methods within the set of transactions and the set of statements within the set of methods may involve detecting and following the programming code employed to respond to the transaction call down to the method call and the statement call. In such examples, the programming code employed to respond to a transaction call may be organized as methods, which are further comprised of individual statement calls or statements.

In some examples, instructions 230 may involve tracing a set of operations associated with the application and sending the set of operations to a filtering device. Sending the set of operations may involve sending the programming code employed by the application associated with the set of operations. The filtering device may receive the set of operations and filter the set of operations to a set of transactions, a set of methods within the set of transactions, and/or a set of statements within the set of methods. In such examples, the filtering device may receive programming code associated with a set of operations and filter or group the programming code by transaction call, by methods within the transaction call, and/or by statements within the methods. In other examples, the filtering device may filter or group the programming code by transaction type, method type, and/or statement type. Such filtering or grouping may involve analyzing the code to determine which code is associated with a particular transaction call, a particular transaction type, a particular method type, or a particular statement type. In some examples, instructions 230 may comprise receiving from the filtering device a set of transactions that are filtered from the set of operations. In other examples, instructions 230 may further comprise receiving from the filtering device a set of methods and/or a set of statements that are filtered from the set of operations.

Based (at least in part) on the set of transactions traced, instructions 240 in the example of FIG. 2A may cause the generation of a transaction interface that includes an area to receive a selection of a transaction of the set of transactions, as described above in relation to instructions 140 of FIG. 1A. As discussed above, a transaction interface may be any interface associated with a set of transactions that allows a customer, client, or user to communicate with a computing device. The transaction interface may be displayed in any manner suitable for representing content associated with the set of transactions. In some examples, the transaction interface may be generated and displayed as a web page or multiple web pages displayed within a web browser. In other examples, the transaction interface may be displayed as an interactive multimedia file within an application performance management service. In yet other examples, the transaction interface may be displayed as a word processing or PDF file.

The transaction interface may include an area to receive a selection of a transaction of the set of transactions. For instance, a transaction interface displayed as a web page within a web browser may display a list of transactions within the set of transactions. Each listed transaction may allow for selection by a user via a click of a mouse button, a touch gesture on a touch-enabled display, or other similar input mechanism.

As discussed above, FIG. 3A depicts an example transaction interface 300 that includes an area to receive a selection of a transaction. In the example of FIG. 3A, transaction interface 300 is shown as a web page within a web browser (though the transaction interface is not limited to such a configuration) and displays transactions related to a “Finance Application.” Transaction interface 300 includes multiple transactions 310, depicted in rows, of the set of transactions. Mouse movement over a transaction 310, as depicted by mouse arrow 305, may cause a button, link, or other indication such as a “+” to appear that allows selection of the transaction 310 by mouse click, touch gesture, or other suitable input mechanism. In other examples, a mouse click or touch gesture over any portion of the row in which transaction 310 is depicted may allow for selection of the transaction 310. In some examples, selection of the “+” indication may allow for monitoring of the specific transaction type, as discussed in further detail with regards to instructions 260 of FIG. 2A below, whereas selection of another portion of the row in which transaction 310 is depicted may display additional information with regards to the particular transaction 310, i.e., when transaction 310 was performed, what entity requested transaction 310, etc. In other examples, selection of a portion of the row in which transaction 310 is depicted other than the “+” indication may display a set of methods within the transaction. In the example depicted in FIG. 3A, selection of the “+” indication allows for selection of the transaction type “MoneyTransferService.”

Returning to the example of FIG. 2A, based (at least in part) on the set of methods traced within the set of transactions, instructions 241 may cause the generation of an area in the transaction interface to receive a selection of a method of the set of methods. For instance, a transaction interface displayed as a web page within a web browser may display a set of methods within a transaction. In some examples, selecting a listed transaction may further display the methods called to perform the transaction. Each listed method may allow for selection by a user via a click of a mouse button, a touch gesture on a touch-enabled display, or other similar input mechanism.

FIG. 3B depicts an example transaction interface 350 that includes an area to receive a selection of a method. In the example of FIG. 3B, transaction interface 350 is shown as a web page within a web browser (though the transaction interface is not limited to such a configuration) and displays transactions and methods related to a “Finance Application.” Transaction interface 350 includes a transaction 310 of the set of transactions and methods 320, depicted in rows, of the set of methods within transaction 310. In some examples, selection of the row in which transaction 310, “MoneyTransferService,” is displayed may further display a set of methods 320 within the transaction 310. The displayed set of methods 320 may be those methods called to perform or execute transaction 310.

Mouse movement over a method 320, as depicted by mouse arrow 305, may cause a button, link, or other indication such as a “+” to appear that allows selection of the method 320 by mouse click, touch gesture, or other suitable input mechanism. In other examples, a mouse click or touch gesture over any portion of the row in which method 320 is depicted may allow for selection of the method 320. In some examples, selection of the “+” indication may allow for monitoring of the specific method type, as discussed in further detail with regards to instructions 262 of FIG. 2A below, whereas selection of another portion of the row in which method 320 is depicted may display additional information with regards to the particular method 320, i.e., when method 320 was performed, what entity requested the transaction that led to the employment of method 320, etc. In other examples, selection of a portion of the row in which method 320 is depicted other than the “+” indication may display a set of statements within the method. In the example depicted in FIG. 3B, selection of the “+” indication allows for selection of the method type “FaultConfigServiceBean/FaultConfigService.”

Returning to the example of FIG. 2A, based (at least in part) on the set of statements traced within the set of methods, instructions 242 may cause the generation of an area in the transaction interface to receive a selection of a statement of the set of statements. For instance, a transaction interface displayed as a web page within a web browser may display a set of statements within a method. In some examples, selecting a listed method may further display the statements called to perform the method. Each listed statement may allow for selection by a user via a click of a mouse button, a touch gesture on a touch-enabled display, or other similar input mechanism.

FIG. 3C depicts an example transaction interface 360 that includes an area to receive a selection of a statement. In the example of FIG. 3C, transaction interface 360 is shown as a web page within a web browser (though the transaction interface is not limited to such a configuration) and displays transactions, methods, and statements related to a “Finance Application.” Transaction interface 360 includes a transaction 310 of the set of transactions, a method 320 of the set of methods, and statements 330, depicted in rows, of the set of statements within method 320. In some examples, selection of the row in which method 320, “FaultConfigServiceBean/FaultConfigService,” is displayed may further display a set of statements 330 within the method 320. The displayed set of statements 330 may be those statements called to perform or execute method 320.

Mouse movement over a statement 330, as depicted by mouse arrow 305, may cause a button, link, or other indication such as a “+” to appear that allows selection of the statement 330 by mouse click, touch gesture, or other suitable input mechanism. In other examples, a mouse click or touch gesture over any portion of the row in which statement 330 is depicted may allow for selection of the statement 330. In some examples, selection of the “+” indication may allow for monitoring of the specific statement type, as discussed in further detail with regards to instructions 264 of FIG. 2A below, whereas selection of another portion of the row in which statement 330 is depicted may display additional information with regards to the particular statement 330, i.e., when statement 330 was performed, what entity requested the transaction that led to the employment of statement 330, etc. In the example depicted in FIG. 3C, selection of the “+” indication allows for selection of the statement type “ConfigServiceClient.getFaultConfigServicePort0.”

In some examples, transaction interfaces 300, 350, and 360 of FIGS. 3A, 3B, and 3C, respectively, may be separate example web pages of the transaction interface generated by instructions 240, 241, and 242 of FIG. 2A. In other examples, transaction interfaces 300, 350, and 360 of FIGS. 3A, 3B, and 3C, respectively, may depict different areas of a single example web page of the transaction interface generated by instructions 240, 241, and 242. In some examples, the transaction interface generated by instructions 240, 241, and 242 may allow a customer, client, or other user to select any number and combination of transactions, methods, and statements. In other examples, the transaction interface may allow for selection of a limited number of transactions, methods, and statements.

Returning again to FIG. 2A, upon selection of a transaction by a customer, client, or other user at the transaction interface, instructions 250 may receive a selected transaction of the set of transactions from the transaction interface, as described above in relation to instructions 150 of FIG. 1A. In some examples, selection of a transaction may automatically assign the transaction type a transaction signature with which to identify the selected transaction. In such examples, receiving the selected transaction may include receiving the transaction signature. In other examples, instructions 250 may receive the selected transaction and assign a transaction signature to the selected transaction.

Upon selection of a method and/or a statement, instructions 251 may receive a selected method of the set of methods and/or a selected statement of the set of statements from the transaction interface. In some examples, selection of a method may automatically assign the method type a method signature with which to identify the selected method. Similarly, selection of a statement may automatically assign the statement type a statement signature with which to identify the selected statement. In such examples, receiving the selected method or statement may include receiving the method signature or statement signature. In other examples, instructions 251 may receive the selected method or statement and assign a method signature or statement signature to the selected method or selected statement, respectively.

Based (at least in part) on the selected transaction, instructions 260 of FIG. 2A may build and apply a transaction monitor rule to the monitored application to monitor the selected transaction, as described above in relation to instructions 160 of FIGS. 1A and 1C. In some examples, as shown in FIG. 2B, instructions 260 to build the transaction monitor rule may comprise instructions 261 to monitor each instance of the selected transaction type. Monitoring a selected transaction may involve detecting and tracing the programming code employed by the application to perform or execute the transaction, including the methods and statements employed to perform or execute the transaction. The selected transaction may be identified by its transaction signature.

As an example, a transaction monitor rule based (at least in part) on the selection of transaction type “MoneyTransferService,” as shown in FIG. 3A, would contain instructions or commands to monitor each instance of the transaction “MoneyTransferService.” In some examples, each instance of the transaction “MoneyTransferService” may be represented by the API call “MoneyTransferService.”

In other examples, the transaction monitor rule may contain instructions or commands to monitor only specific instances of a particular transaction type, for example, each instance originating from a certain entity or each instance occurring within a certain time frame. In such examples, upon selection of a transaction of the set of transactions, a user may be prompted to select additional qualifiers to build the transaction monitor rule. Instructions 260 may automatically and dynamically build the transaction monitor rule upon selection of the selected transaction and/or selection of additional qualifiers.

Based (at least in part) on a selected method, instructions 262 of FIG. 2A may build and apply a method monitor rule to the monitored application to monitor the selected method. As used herein, a method monitor rule may refer to a rule to monitor the selected method. In some examples, as shown in FIG. 2B, instructions 262 to build the method monitor rule may comprise instructions 263 to monitor each instance of the selected method type. Monitoring a selected method may involve detecting and tracing the programming code employed by the application to perform or execute the method, including the statements employed to perform or execute the method. The selected method may be identified by its method signature. The selected statement may be identified by its statement signature.

As an example, a method monitor rule based (at least in part) on the selection of method type “FaultConfigServiceBean/FaultConfigService,” as shown in FIG. 3B, would contain instructions or commands to monitor each instance of the method “FaultConfigServiceBean/FaultConfigService.” In other examples, the method monitor rule may contain instructions or commands to monitor only specific instances of the particular method type, for example, each instance originating from a certain transaction or each instance occurring within a certain time frame. In such examples, upon selection of a method of the set of methods, a user may be prompted to select additional qualifiers to build the method monitor rule. Instructions 262 may automatically and dynamically build the method monitor rule upon selection of the method and/or selection of additional qualifiers.

Based (at least in part) on a selected statement, instructions 264 of FIG. 2A may build and apply a statement monitor rule to the monitored application to monitor the selected statement. As used herein, a statement monitor rule may refer to a rule to monitor the selected statement. In some examples, as shown in FIG. 2B, instructions 264 to build the statement monitor rule may comprise instructions 265 to monitor each instance of the selected statement or statements similar to the selected statement. Monitoring a selected statement may involve detecting and tracing the programming code employed by the application to perform or execute the statement.

As an example, a statement monitor rule based (at least in part) on the selection of statement type “ConfigServiceClient.getFaultConfigServicePort0,” as shown in FIG. 3C, would contain instructions or commands to monitor each instance of the statement “ConfigServiceClient.getFauftConfigServicePort0.” In other examples, the statement monitor rule may contain instructions or commands to monitor statements similar to the selected statement. In yet other examples, statement monitor rule may contain instructions or commands to monitor only specific instances of the particular statement, for example, each instance originating from a certain method or each instance occurring within a certain time frame. In such examples, upon selection of a statement of the set of statements, a user may be prompted to select additional qualifiers to build the statement monitor rule. Instructions 264 may automatically and dynamically build the statement monitor rule upon selection of the statement and/or selection of additional qualifiers.

In the example of FIG. 2A, based (at least in part) on the transaction monitor rule, instructions 270 may cause the generation of a performance interface that includes an area having transaction performance information of the selected transaction, as described above in relation to instructions 170 of FIG. 1A. As discussed above, the performance interface may be displayed in any manner suitable for representing content associated with the selected transaction. In some examples, the performance interface may be generated and displayed as a web page or multiple web pages displayed within a web browser. In other examples, the performance interface may be displayed as an interactive multimedia file within an application performance management service. In yet other examples, the performance interface may be displayed as a word processing or PDF file.

Instructions 270 may cause the generation of a performance interface by requesting or otherwise receiving information gathered due to the transaction monitor rule. In some examples, this information may be located at computing device 200 or at a remote, but accessible device or storage medium to computing device 200. This information may include, among other things, the programming code employed to respond to each instance of the selected transaction (including each method and statement employed), the latency of each instance of the selected transaction, and/or error messages generated in the performance or execution of a transaction. Analytics may be performed on this information to generate transaction performance information.

The performance interface may include an area having transaction performance information of the selected transaction. As used in the examples herein, transaction performance information may refer to performance information related to the selected transaction. For instance, depending on the transaction monitor rule, the performance interface may display each instance (i.e., transaction call) of the selected transaction, the latency of each instance of the selected transaction, an average latency for the selected transaction, the percentage of the selected transactions that fail, the number of selected transaction calls per minute, an operation flow of the selected transaction depicting the set of operations and actions (including the methods and statements) that comprise the transaction, information about the individual operations within the operation flow such as latency and failure rate, and a log message capture of error or fault messages per instance of the selected transaction or in the aggregate.

As discussed above, FIG. 4A depicts an example performance interface 400 that includes an area 410 having transaction performance information of the selected transaction. In the example of FIG. 4A, performance interface 400 is shown as a web page within a web browser (though the performance interface is not limited to such a configuration) and displays the performance of a transaction related to a “Finance Application.” Area 410 of performance interface 400 depicts transaction performance information related to the selected transaction “MoneyTransferService.” As shown, area 410 includes transaction performance information relating to the average server time for the transaction “MoneyTransferService,” the percentage of transactions failed, and the number of transaction calls per minute. Though not shown in performance interface 400, the performance interface may include additional areas to allow for the display of further transaction performance information. In some examples, the performance interface may allow a customer, client, or user to select and display transaction performance information that shows, among other things, an operation flow of the selected transaction, which may include the methods or statements employed to perform the transaction, or a log message capture of the selected transaction.

In the example of FIG. 2A, based (at least in part) on the method monitor rule, instructions 271 may cause the generation of an area within the performance interface having method performance information of the selected method. As used in the examples herein, method performance information may refer to performance information related to the selected method. For instance, a performance interface displayed as a web page within a web browser may display an area having performance information for the selected method.

Instructions 271 may request or otherwise receive information gathered due to the method monitor rule. In some examples, this information may be located at computing device 200 or at a remote, but accessible device or storage medium to computing device 200. This information may include, among other things, the programming code employed to respond to each instance of the selected method (including each statement employed), the latency of each instance of the selected method, and/or error messages generated in the performance or execution of the method. Analytics may be performed on this information to generate the method performance information.

Depending on the method monitor rule, the performance interface may display each instance of the selected method, the latency of each instance of the selected method, an average latency for the selected method, the percentage of the selected methods that fail, the number of selected method calls per minute, an operation flow of the selected method depicting the set of operations and actions (including the statements) that comprise the method, information about the individual statements within the operation flow such as latency and failure rate, and a log message capture of error or fault messages per instance of the selected method or in the aggregate.

FIG. 4B depicts an example performance interface 420 that includes an area 430 having method performance information of the selected method. In the example of FIG. 4B, performance interface 420 is shown as a web page within a web browser (though the performance interface is not limited to such a configuration) and displays the performance of a method related to a “Finance Application.” Area 430 of performance interface 420 depicts method performance information related to the selected method “FaultConfigService.” As shown, area 430 includes method performance information relating to the average server time for the method “FaultConfigService,” the percentage of methods failed, and the number of method calls per minute. Though not shown in performance interface 420, the performance interface may include additional areas to allow for the display of further method performance information. In some examples, the performance interface may allow a customer, client, or user to select and display method performance information that shows, among other things, an operation flow of the selected method, which may include the statements employed to perform the method, or a log message capture of the selected method.

In the example of FIG. 2A, based (at least in part) on the statement monitor rule, instructions 272 may cause the generation of an area within the performance interface having statement performance information of the selected statement. As used in the examples herein, statement performance information may refer to performance information related to the selected statement. For instance, a performance interface displayed as a web page within a web browser may display an area having performance information for the selected statement.

Instructions 272 may request or otherwise receive information gathered due to the statement monitor rule. In some examples, this information may be located at computing device 200 or at a remote, but accessible device or storage medium to computing device 200. This information may include, among other things, the programming code employed to respond to each instance of the selected statement, the latency of each instance of the selected statement, and/or error messages generated in the performance or execution of the statement. Analytics may be performed on this information to generate the statement performance information.

Depending on the statement monitor rule, the performance interface may display each instance of the selected statement, the latency of each instance of the selected statement, an average latency for the selected statement, the percentage of the selected statements that fail, the number of selected statement calls per minute, and a log message capture of error or fault messages per instance of the selected statement or in the aggregate.

FIG. 4C depicts an example performance interface 440 that includes an area 450 having statement performance information of the selected statement. In the example of FIG. 4C, performance interface 440 is shown as a web page within a web browser (though the performance interface is not limited to such a configuration) and displays the performance of a statement related to a “Finance Application.” Area 450 of performance interface 440 depicts statement performance information related to the selected statement “GetFaultConfigServicePort0.” As shown, area 450 includes statement performance information relating to the average server time for the statement “GetFaultConfigServicePort0,” the percentage of statements failed, and the number of statement calls per minute. Though not shown in performance interface 440, the performance interface may include additional areas to allow for the display of further statement performance information. In some examples, the performance interface may allow a customer, client, or user to select and display statement performance information that shows, among other things, each instance of the selected statement, the latency of each instance of the selected statement, and/or a log message capture of the selected method.

In some examples, performance interfaces 400, 420, and 440 of FIGS. 4A, 48, and 4C, respectively, may be separate example web pages of the performance interface generated by instructions 270, 271, and 272 of FIG. 2A. In other examples, performance interfaces 400, 420, and 440 of FIGS. 4A, 48, and 4C, respectively, may depict different areas of a single example web page of the performance interface generated by instructions 270, 271, and 272. In some examples, the performance interface generated by instructions 270, 271, and 272 may depict transaction performance information, method performance information, and/or statement performance information for multiple selected transactions, selected methods, and/or selected statements. In some such examples, user may configure or organize the depiction of this information per a desired order or priority configuration.

In the example of FIG. 2A, based on the selected transaction, selected method, and/or selected statement, a rule interface may also be generated that includes an area that has each selected transaction, an area that has each selected method, and/or an area that has each selected statement. The rule interface may be displayed in any manner suitable for representing content that includes each selected transaction, each selected method, and/or each selected statement. In some examples, the rule interface may be generated and displayed as a web page or multiple web pages displayed within a web browser. In other examples, the rule interface may be displayed as an interactive multimedia file within an application performance management service. In yet other examples, the rule interface may be displayed as a word processing or PDF file.

In some examples, the rule interface may be generated by requesting or otherwise receiving information related to each selected transaction, each selected method, and/or each selected statement. The rule interface may include an area having each selected transaction, each selected method, and each selected statement. For example, each selected transaction, method, and statement may be listed or otherwise depicted in the rule interface. FIG. 5 depicts an example rule interface 500 that includes an area 510 having each selected transaction, an area 520 having each selected method, and an area 530 having each selected statement. In the example of FIG. 5, rule interface 500 is shown as a web page within a web browser (though the rule interface is not limited to this configuration) and displays each selected transaction, method, and statement related to a “Finance Application.”

Area 510 of rule interface 500 depicts the selected transaction “MoneyTransferService.” In some examples, though not illustrated in FIG. 5, a customer, client, or user may de-select a selected transaction, causing the removal of the transaction monitor rule. In some such examples, mouse movement over a listed transaction may cause a button, link, or other indication such as a “−” to appear that allows de-selection of the transaction by mouse click, touch gesture, or other suitable input mechanism. In other examples, a mouse click or touch gesture over any portion of the row in which the selected transaction is depicted may allow for de-selection of the transaction. In some examples, selection of the “−” indication may discontinue specific monitoring of the transaction type, whereas selection of another portion of the row in which the transaction is depicted may display additional information with regards to the particular transaction, i.e., when the selected transaction was last performed, when selection of the selected transaction was requested, etc.

Area 520 of rule interface 500 depicts the selected method “FaultConfigServiceBean/FaultConfigService.” In some examples, though not illustrated in FIG. 5, a customer, client, or user may de-select a selected method, causing the removal of the method monitor rule. In some such examples, mouse movement over a listed method may cause a button, link, or other indication such as a “−” to appear that allows de-selection of the method by mouse click, touch gesture, or other suitable input mechanism. In other examples, a mouse click or touch gesture over any portion of the row in which the selected method is depicted may allow for de-selection of the method. In some examples, selection of the “−” indication may discontinue specific monitoring of the method type, whereas selection of another portion of the row in which the method is depicted may display additional information with regards to the particular method, i.e., when the selected method was last performed, when selection of the selected method was requested, etc.

Area 530 of rule interface 500 depicts the selected statement “ConfigServiceClient.getFaultConfigServicePort0.” In some examples, though not illustrated in FIG. 5, a customer, client, or user may de-select a selected statement, causing the removal of the statement monitor rule. In some such examples, mouse movement over a listed statement may cause a button, link, or other indication such as a “−” to appear that allows de-selection of the statement by mouse click, touch gesture, or other suitable input mechanism. In other examples, a mouse click or touch gesture over any portion of the row in which the selected statement is depicted may allow for de-selection of the statement. In some examples, selection of the “−” indication may discontinue specific monitoring of the statement type, whereas selection of another portion of the row in which the statement is depicted may display additional information with regards to the particular statement, i.e., when the selected statement was last performed, when selection of the selected statement was requested, etc.

In some examples, instructions 230, 234, 235, 240, 241, 242, 250, 251, 260, 262, 264, 270, 271, and 272 may be part of an installation package that, when installed, may be executed by processor 210 to implement the functionalities described above. In such examples, storage medium 220 may be a portable medium, such as a CD, DVD, or flash drive, or a memory maintained by a server from which the installation package can be downloaded and installed. In other examples, instructions 230, 234, 235, 240, 241, 242, 250, 251, 260, 262, 264, 270, 271, and 272 may be part of an application, applications, or component(s) already installed on computing device 200 including processor 210. In such examples, the storage medium 220 may include memory such as a hard drive, solid state drive, or the like. In some examples, functionalities described herein in relation to any of FIGS. 2-5 may be provided in combination with functionalities described herein in relation to any of FIGS. 1 and 6-7.

FIG. 6A is a block diagram of an example computing device 600 to monitor performance of an application by receiving from a filtering device, a set of transactions. In the example of FIG. 6A, computing device 600 includes a processor 610, which communicates with a filtering device 630, and a user interface 620. User interface 620 may also include a transaction interface 630 and a performance interface 640.

As used herein, a computing device may be a desktop computer, laptop (or notebook) computer, workstation, tablet computer, mobile phone, smart device, switch, router, server, blade enclosure, or any other processing device or equipment including a processor or processing resource. In examples described herein, a processor may include, for example, one processor or multiple processors included in a single computing device or distributed across multiple computing devices.

As used herein, a processor may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processor 610 may perform the functionalities described above in relation to instructions 130, 140, 150, 160, and 170 of FIGS. 1A-C.

In the example of FIG. 6A, processor 610 may trace a set of operations associated with an application. As used in the examples herein, a set of operations may refer to any functions, tasks, or activities performed by an application. In some examples, tracing a set of operations may encompass or involve tracing a set of transactions. The operations associated with the application may include any response by the application to a transaction call, for instance an API call, as well as any other actions taken, or functions and tasks performed by the application. Tracing a set of operations may involve detecting some or all of the programming code employed by the application. In some examples, processor 610 may implement the functionality discussed above in relation to instructions 130 and 131 of FIGS. 1A and 1B, respectively.

Processor 610 may then send the set of operations to a filtering device 630. A filtering device, as used herein, may refer to a device that receives a set of operations and filters the operations. Filtering device 630 may be located remote from, but accessible to computing device 600 (e.g., via a computer network), as shown. In other examples, filtering device 630 may be part of computing device 600. In some examples, filtering device 630 may receive a set of operations and filter the set of operations to a set of transactions. In such examples, the filtering device may receive programming code associated with a set of operations and filter or group the programming code by transaction type or by transaction call. Such filtering or grouping may involve analyzing the code to determine which code is associated with a particular transaction call or a particular transaction type. In some examples, processor 610 may implement the functionality discussed above in relation to instructions 132 of FIG. 1A. Processor 610 may receive from filtering device 630 the set of transactions filtered from the set of operations. In some examples, processor 160 may implement the functionality discussed above in relation to instructions 133 of FIG. 1B.

Based (at least in part) on the set of transactions, processor 610 may generate a transaction interface 630 within user interface 620. As used herein, a user interface may refer to a part of computing device 600 that may allow a customer, client, or other user to interact with computing device 600. In some examples, user interface 620 may be a graphical user interface (GUI), a web-based user interface, a touch user interface, and/or a hardware interface. Processor 610 may generate transaction interface 630 to include an area 632 to receive a selection of a transaction of the set of transactions. In some examples, processor 610 may implement the functionality described above in relation to instructions 140 of FIG. 1A and transaction interface 300 of FIG. 3A.

Upon selection of a transaction by a customer, client, or other user at transaction interface 630 of user interface 620, processor 610 may receive the selected transaction of the set of transactions. In some examples, selection of a transaction may automatically assign the transaction type a transaction signature with which to identify the selected transaction. In such examples, receiving the selected transaction may include receiving the transaction signature. In other examples, processor 610 may receive the selected transaction and assign a transaction signature to the selected transaction. In some examples, processor 610 may implement the functionality described above in relation to instructions 150 of FIG. 1A.

Based (at least in part) on the selected transaction, processor 610 may build and apply a transaction monitor rule to the monitored application to monitor the selected transaction. Monitoring a selected transaction may involve detecting and tracing the programming code employed by the application to perform or execute the transaction. The selected transaction may be identified by its transaction signature. The transaction monitor rule may monitor each instance of the selected transaction type or, depending on if the transaction monitor rule involves additional qualifiers, may monitor only particular instances of the selected transaction type. In some examples, processor 610 may implement the functionality described above in relation to instructions 160 and 161 of FIGS. 1A and 1C, respectively.

Based (at least in part) on the transaction monitor rule, processor 610 may generate a performance interface 640 within user interface 620. Performance interface 640 may include an area 642 having transaction performance information of the selected transaction. In some examples, processor 610 may implement the functionality described above in relation to instructions 170 of FIG. 1A and performance interface 400 of FIG. 4A.

FIG. 6B is a block diagram of an example computing device 600 to monitor performance of an application by tracing a set of transactions, a set of methods, and a set of statements. In the example of FIG. 6B, computing device 600 includes processor 610, which communicates with filtering device 630, and user interface 620. User interface 620 may also include transaction interface 630 and performance interface 640.

As used herein, a computing device may be a desktop computer, laptop (or notebook) computer, workstation, tablet computer, mobile phone, smart device, switch, router, server, blade enclosure, or any other processing device or equipment including a processor or processing resource. In examples described herein, a processor may include, for example, one processor or multiple processors included in a single computing device or distributed across multiple computing devices.

As used herein, a processor may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processor 610 may perform the functionalities described above in relation to instructions 130, 140, 150, 160, 170, and 180 of FIG. 1 and/or instructions 230, 234, 235, 240, 241, 242, 250, 251, 260, 262, 264, 270, 271, and 272 of FIG. 2A.

In the example of FIG. 6B, processor 610 may trace a set of operations associated with an application, as described above in relation to FIG. 6A. Processor 610 may then send the set of operations to a filtering device 630, as described above in relation to FIG. 6A. A filtering device, as used herein, may refer to a device that receives a set of operations and filters the operations. Filtering device 630 may be located remote from, but accessible to computing device 600 (e.g., via a computer network), as shown. In other examples, filtering device 630 may be part of computing device 600. In some examples, filtering device 630 may receive a set of operations and filter the set of operations to a set of transactions. In addition, filtering device 630 may filter the set of transactions to a set of methods within the set of transactions and a set of statements within the set of methods. In such examples, filtering device 630 may receive programming code associated with a set of operations and filter or group the programming code by transaction call, by methods within the transaction call, and/or by statements within the methods. In other examples, filtering device 630 may filter or group the programming code by transaction type, method type, and/or statement type. Such filtering or grouping may involve analyzing the code to determine which code is associated with a particular transaction call, a particular transaction type, a particular method type, or a particular statement type.

Processor 610 may receive from filtering device 630 the set of transactions filtered from the set of operations. Processor 610 may additionally receive from filtering device 630 the set of methods and/or the set of statements that are filtered from the set of operations. In some examples, processor 610 may implement the functionality described above in relation to instructions 130 of FIG. 1A, instructions 133 of FIG. 1B, and instructions 230 of FIG. 2A.

Based (at least in part) on the set of transactions, processor 610 may generate a transaction interface 630 within user interface 620. Processor 610 may generate transaction interface 630 to include an area 632 to receive a selection of a transaction of the set of transactions, as described above in relation to FIG. 6A. Processor 610 may also generate an area 634 within transaction interface 630 to receive a selection of a method of the set of methods, as described above in relation to instructions 241 of FIG. 2A and transaction interface 350 of FIG. 3B. Processor 610 may additionally generate an area 636 within transaction interface 630 to receive a selection of a statement of the set of statements, as described above in relation to instructions 242 of FIG. 2A and transaction interface 360 of FIG. 3C.

Upon selection of a transaction by a customer, client, or other user at transaction interface 630 of user interface 620, processor 610 may receive the selected transaction of the set of transactions, as described above in relation to FIG. 6A. Upon selection of a method and/or a statement by a customer, client, or other user at transaction interface 630, processor 610 may additionally receive the selected method and/or statement. In some examples, selection of a method may automatically assign the method type a method signature with which to identify the selected method. Similarly, selection of a statement may automatically assign the statement type a statement signature with which to identify the selected statement. In such examples, receiving the selected method or statement may include receiving the method signature or statement signature. In other examples, processor 610 may receive the selected method or statement and assign a method signature or statement signature to the selected method or selected statement, respectively. In some examples, processor 610 may implement the functionality described above in relation to instructions 250 and 251 of FIG. 2A.

Based (at least in part) on the selected transaction, processor 610 may build and apply a transaction monitor rule to the monitored application to monitor the selected transaction, as described above in relation to FIG. 6A. In addition, based (at least in part) on the selected method, processor 610 may build and apply a method monitor rule to the monitored application to monitor the selected method. The selected method may be identified by its method signature. In some examples, processor 610 may implement the functionality described above in relation to instructions 262 and 263 of FIGS. 2B and 2C, respectively. Based (at least in part) on the selected statement, processor 610 may build and apply a statement monitor rule to the monitored application to monitor the selected statement. The selected statement may be identified by its statement signature. In some examples, processor 610 may implement the functionality described above in relation to instructions 264 and 265 of FIGS. 2B and 2C.

Based (at least in part) on the transaction monitor rule, processor 610 may generate a performance interface 640 within user interface 620. Performance interface 640 may include an area 642 having transaction performance information of the selected transaction, as described above in relation to FIG. 6A. Based (at least in part) on the method monitor rule, processor 610 may also generate an area 644 within performance interface 640 having method performance information of the selected method. In some examples, processor 610 may implement the functionality described above in relation to instructions 271 of FIG. 2A and performance interface 420 of FIG. 4B. Based (at least in part) on the statement monitor rule, processor 610 may also generate an area 646 within performance interface 640 having statement performance information of the selected statement. In some examples, processor 610 may implement the functionality described above in relation to instructions 272 of FIG. 2A and performance interface 440 of FIG. 4C.

Processor 110 may also generate a rule interface 650 within user interface 620. Rule interface 650 may include an area that has each selected transaction, an area that has each selected method, and an area that has each selected statement. In some examples, processor 610 may implement the functionality described above in relation to instructions 180 of FIG. 1D and rule interface 500 of FIG. 5.

FIG. 7 is a flowchart of an example method 700 of monitoring performance of an application including tracing a set of transactions a set of methods, and a set of statements. Execution of method 700 is described below with reference to various features of computing device 200 of FIG. 2A, but other suitable systems for the execution of method 700 can also be utilized (e.g., computing device 100 of FIGS. 1A and 10D). Additionally, implementation of method 700 is not limited to such examples.

In the example of FIG. 7, method 700 may be a method of computing device 200. At 710, a processor may trace a set of transactions, a set of methods, and a set of statements. This tracing may be performed as described above in relation to instructions 230, 234 and 235 of FIG. 2A. In some examples, this tracing may also be performed as described above in relation to instructions 130 and 131 of FIGS. 1A and 1B. At 720, a processor may generate a transaction interface that includes an area to receive a selection of a transaction of the set of transactions, an area to receive a selection of a method of the set of methods, and an area to receive a selection of a statement of the set of statements. The transaction interface may be generated as described above in relation to instructions 240, 241, and 242 of FIG. 2A.

At 730, the processor may receive a selected transaction. This receipt may be performed as described above in relation to instructions 250 of FIG. 2A. If the processor receives a selected transaction, method 700 may proceed to 735, where the processor may build a transaction monitor rule based (at least in part) on the selected transaction. The building of the transaction monitor rule may be performed as described above in relation to instructions 260 and 261 of FIGS. 2A and 2B. At 760, based (at least in part) on the transaction monitor rule, the processor may generate a performance interface that includes an area having transaction performance information of the selected transaction.

If, at 730, the processor does not receive a selected transaction, method 700 may proceed to 740, where the processor may receive a selected method. If the processor receives a selected method, method 700 may proceed to 745, where the processor may build a method monitor rule based (at least in part) on the selected method. The building of the method monitor rule may be performed as described above in relation to instructions 262 and 263 of FIGS. 2A and 2B. At 760, based (at least in part) on the method monitor rule, the processor may generate a performance interface that includes an area having method performance information of the selected method. In some examples, method 700 may proceed to 740 in addition to proceeding to step 735 when a selected transaction is received at 730.

If, at 740, the processor does not receive a selected method, method 700 may proceed to 750, where the processor may receive a selected statement. If the processor receives a selected statement, method 700 may proceed to 755, where the processor may build a statement monitor rule based (at least in part) on the selected statement. The building of the statement monitor rule may be performed as described above in relation to instructions 264 and 265 of FIGS. 2A and 2B. At 760, based (at least in part) on the statement monitor rule, the processor may generate a performance interface that includes an area having statement performance information of the selected statement. In some examples, method 700 may proceed to 750 in addition to proceeding to step 745 when a selected method is received at 740. If, at 750, the processor does not receive any of a selected transaction, a selected method, or a selected statement, method 700 may return to 730.

Although the flowchart of FIG. 7 shows a specific order of performance of certain functionalities, method 700 may not be limited to that order. For example, the functionalities shown in succession in the flowchart may be performed in a different order, may be executed concurrently or with partial concurrence, or a combination thereof. In some examples, functionalities described herein in relation to FIG. 7 may be provided in combination with functionalities described herein in relation to any of FIGS. 1 and 3-6.

What is claimed is:

1. A machine-readable storage medium encoded with instructions executable by a processor of a computing device to monitor performance of an application, the machine-readable storage medium comprising instructions to:
trace a set of transactions associated with the application;
cause the generation of a transaction interface, wherein the transaction interface includes an area to receive a selection of a transaction of the set of transactions;
receive a selected transaction of the set of transactions;
build, based on the selected transaction, a transaction monitor rule to monitor the selected transaction; and
cause the generation of, based on the transaction monitor rule, a performance interface, wherein the performance interface includes an area having transaction performance information of the selected transaction.

2. The machine-readable storage medium of claim 1, wherein the instructions to trace the set of transactions further comprise instructions to:
trace a set of operations associated with the application, wherein the set of operations includes the set of transactions and each transaction of the set of transactions is initiated via an application programming interface call;
send, to a filtering device, the set of operations; and
receive, from the filtering device, the set of transactions.

3. The machine-readable storage medium of claim 1, wherein the instructions to build the transaction monitor rule further comprise instructions to:
monitor each instance of the selected transaction, wherein the selected transaction includes a transaction signature to identify each instance of the selected transaction.

4. The machine-readable storage medium of claim 1, wherein the instructions to trace the set of transactions further comprise instructions to:
trace a set of methods within the set of transactions; and
trace a set of statements within the set of methods.

5. The machine-readable storage medium of claim 4, the machine-readable storage medium further comprising instructions to:
cause the generation of an area in the transaction interface to receive a selection of a method of the set of methods;
cause the generation of an area in the transaction interface to receive a selection of a statement of the set of statements;
receive at least one of a selected method and a selected statement;
build, based on the selected method, a method monitor rule to monitor the selected method; and
build, based on the selected statement, a statement monitor rule to monitor the selected statement.

6. The machine-readable storage medium of claim 5, the machine-readable storage medium further comprising instructions to:
cause the generation of an area in the performance interface having method performance information of the selected method; and
cause the generation of an area in the performance interface having statement performance information of the selected statement.

7. The machine-readable storage medium of claim 1, wherein the transaction performance information includes at least one of a latency of the selected transaction, an operation flow of the selected transaction, and a log message capture of the selected transaction.

8. The machine-readable storage medium of claim 1, further comprising instructions to:
cause the generation of a rule interface, wherein the rule interface includes an area having each selected transaction.

9. A computing device for monitoring performance of an application, comprising:
a user interface; and
a processor to:
trace a set of operations associated with an application,
send, to a filtering device, the set of operations;
receive, from the filtering device, a set of transactions within the set of operations;
generate a transaction interface in the user interface, wherein the transaction interface includes an area to receive a selection of a transaction of the set of transactions,
receive a selected transaction of the set of transactions,
build, based on the selected transaction, a transaction monitor rule to monitor the selected transaction, and
generate, based on the transaction monitor rule, a performance interface in the user interface that includes transaction performance information of the selected transaction.

10. The computing device of claim 9, wherein tracing the set of operations further includes:
tracing the set of transactions within the set of operations;
tracing a set of methods within the set of transactions; and
tracing a set of statements within the set of methods.

11. The computing device of claim 10, further comprising the processor to:
generate the transaction interface, wherein the transaction interface includes an area to receive a selection of a method of the set of methods and an area to receive a selection of a statement of the set of statements;
receive at least one of a selected method and a selected statement;
build, based on the selected method, a method monitor rule to monitor the selected method; and
build, based on the selected statement, a statement monitor rule to monitor the selected statement.

12. The computing device of claim 10, wherein the performance interface further includes at least one of method performance information of the selected method and statement performance information of the selected statement.

13. A method for monitoring performance of an application, comprising:
tracing a set of transactions associated with the application, a set of methods within the set of transactions, and a set of statements within the plurality of methods;
generating a transaction interface, wherein the transaction interface includes an area to receive a selection of a transaction of the set of transactions, an area to receive a selection of a method of the set of methods, and an area to receive a selection of a statement of the set of statements;
receiving at least one of a selected transaction, a selected method, and a selected statement;
building at least one of:
a transaction monitor rule, based on the selected transaction, to monitor the selected transaction,
a method monitor rule, based on the selected method, to monitor the selected method, and
a statement monitor rule, based on the selected statement, to monitor the selected statement; and
generating a performance interface that includes at least one of:
an area having transaction performance information of the selected transaction based on the transaction monitor rule,
an area having method performance information of the selected method based on the method monitor rule, and
an area having statement performance information of the selected statement based on the statement monitor rule.

14. The method of claim 13, wherein the transaction monitor rule includes monitoring each instance of the selected transaction, the method monitor rule includes monitoring each instance of the selected method, and the statement monitor rule includes monitoring each instance of the statement.

15. The method of claim 13, wherein the selected transaction includes a transaction signature to identify each instance of the selected transaction, the selected method includes a method signature to identify each instance of the selected method, and the selected statement includes a statement signature to identify each instance of the selected statement.
